(19) United States
(12) Patent Application Publication
(10) Pub. No.: US 2022/0065994 A1
(43) Pub. Date: Mar. 3, 2022

(54) LIGHT DETECTION AND RANGING SYSTEM

(71) Applicant: Intel Corporation, Santa Clara, CA (US)

(72) Inventors: Zhi LI, San Jose, CA (US); Jonathan DOYLEND, Morgan Hill, CA (US); Ansheng LIU, Cupertino, CA (US); Faraz MONIFI, Mountain View, CA (US)

(21) Appl. No.: 17/522,933

(22) Filed: Nov. 10, 2021

(51) Int. Cl. G01S 7/481; G02F 1/21; G02F 1/225; G02F 1/01

(52) U.S. Cl. CPC G01S 7/4814; G02F 1/212; G02F 1/217; G02F 2203/50; G02F 1/0147; G02F 2203/25; G02F 1/225

(57) ABSTRACT

A light detection and ranging system that may include a light source configured to provide a second optical input signal to a second input port of a multimode interferometer that is phase shifted to a first optical input signal provided to a first input port of the multimode interferometer. The multimode interferometer is configured to provide a second optical output signal to a second optical channel coupled to a second output port of the multimode interferometer, and to provide a first optical output signal to a first optical channel coupled to a first output port of the multimode interferometer. Each of the first optical channel and the second optical channel is configured to emit light to an outside of the light detection and ranging system, and wherein the multimode interferometer is configured to generate a frequency difference between the first optical output signal and the second optical output signal.

### TECHNICAL FIELD

This disclosure generally relates to the field of light detection and ranging systems.

### BACKGROUND

A solid-state Frequency Modulated Continuous Wave (FMCW) Light Detection and Ranging (LIDAR) system uses modulated infrared continuous wave (CW) infrared light as the LIDAR light source. The modulated light source needs to provide high optical power for long range detection or low visibility environment. One of the modulation methods for the LIDAR light source is carrier-suppressed single-sideband-modulation (CS-SSB) using photonic In-phase and quadrature modulation (IQ-modulator). The CS-SSB modulator based light source can provide multi-GHz of chirping range. In usual applications, e.g. a coherent transceiver, a photonic IQ-modulator uses a 2×1 multi-mode interferometer (MMI) to combine I- and Q-optical carriers of the IQ-modulation. A Coherent transceiver having an IQ-modulator with 2×2 MMI combiner is also known. However, in the known 2×2 MMI combiner, one of the two output ports of the 2×2 MMI combiner is either terminated or connected to a power monitor photodiode due to the incoherency of the signals from the 2 outputs. Thus, the known 2×2 MMI combiner uses only one of the outputs for LIDAR detection. Thus, in the known MMI combiner, half of the optical output power is lost (3 dB loss) due to optical scattering in the 2×1 MMI combiner, or due to the terminated output of the 2×2 MMI combiner. Thus, a usual IQ-modulator based light source will lose 50% of its optical output power.

A known approach of a modulation method to reduce the optical power loss is to directly tune the wavelength of a light source. However, modulation linearity is highly dependent on the wavelength tuning range. The chirping range is limited to under 1 GHz due to the large RC-time constant of a tunable laser.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A and FIG. 1B illustrate schematic diagrams of comparative examples of LIDAR systems;

FIG. 1C illustrates a schematic diagram of an example of a LIDAR system;

FIG. 2A and FIG. 2B illustrate a port notation of multimode interference combiners;

FIG. 3 illustrates a schematic diagram of an example of a LIDAR system;

FIG. 4 illustrates a schematic diagram of an emitter-detector structure;

FIG. 5A and FIG. 5B illustrate power spectrums of an exemplary multimode interference combiner; and

FIG. 6 illustrates a schematic diagram of a vehicle having a LIDAR system.

### DESCRIPTION

The LIDAR system includes an IQ-modulator based light source configuration with at least two outputs to optically power the LIDAR system. Thus, the light source utilizes all optical power without 3 dB loss of known MMI combiners. Further, the outputs of the light source can power two or more separate LIDAR systems. Alternatively, or in addition, two outputs of the light source can power one single LIDAR system incoherently at a time. As an example, the light source can optically power one or more LIDAR systems, e.g. in a time multiplexed manner. In case the light source powers one LIDAR system, the optical amplification on the LIDAR system can be relaxed. This way, as an example, the overall power consumption for the LIDAR system can be reduced. In case the light source powers two or more separate LIDAR systems, the required number of modulated light source(s) can be reduced by one or more.

The LIDAR system including the IQ-modulator based light source may be used as a component in an autonomous vehicle, autonomous robot, or autonomous UAV or drone, to sense objects, internally as well as externally. The LIDAR system may also be used for assistance systems in vehicles, robots, UAVs or drones. The LIDAR system may be part of a multimodal sensing system, operating alongside or in combination with cameras, radar, ultrasound, or mm-wave ultra-wideband (UWB). Navigation and autonomous or assisted decision-making may be based wholly or in part on the LIDAR system. In addition, the LIDAR system may be used in mobile devices such as smartphones, tablets or laptops for purposes including environment, object, person, posture or gesture detection.

The following detailed description refers to the accompanying drawings that show, by way of illustration, specific details and aspects in which the invention may be practiced.

The term “as an example” is used herein to mean “serving as an example, instance, or illustration”. Any aspect or design described herein as “as an example” is not necessarily to be construed as preferred or advantageous over other aspects or designs.

Illustratively, a 2×2 MMI of a light source of a LIDAR system mixes In-phase carrier and quadrature carrier while in operation. The 2×2 MMI includes an I-input and Q-input, and a first output and a second output. The two outputs, e.g. the first and second outputs, of the 2×2 MMI of the light source generate carrier suppressed upper side band and lower side band signals respectively. The two outputs of the 2×2 MMI of the light source can serve as input chirping signals for the LIDAR system, e.g. for an output ranging signal of the LIDAR system. This way, LIDAR systems power consumption may be reduced.

The signals output from the outputs of the 2×2 MMI of the light source may be incoherent to each other. Without coherency, the separate single side-band property of the dual outputs provide additional benefit for no interference between the 2 ranging signals. This dual output light source can be an individual chip to connect externally to the LIDAR system, or it can be monolithically integrated on the LIDAR system. This light source can also serve to two or more individual LIDAR systems simultaneously when it is connected externally.

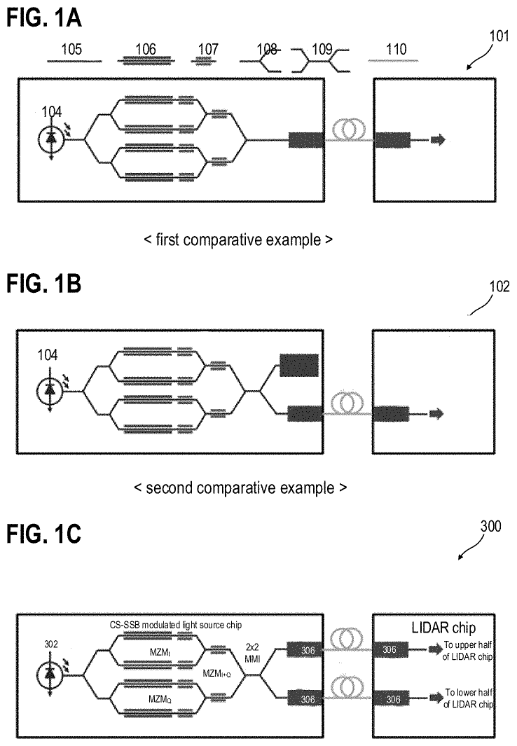

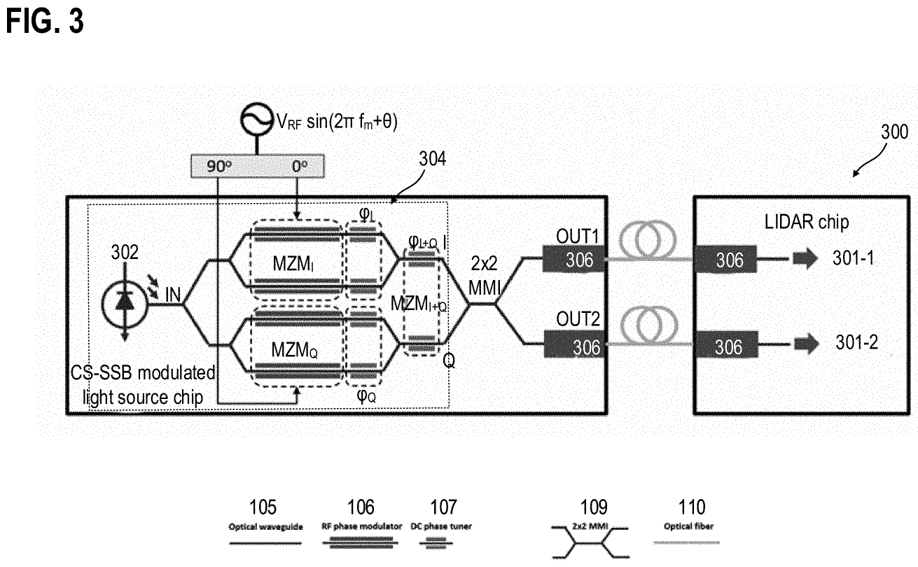

FIG. 1A, FIG. 1B and FIG. 1C illustrate external light source configurations for LIDAR systems. Various components illustrated in FIG. 1A to FIG. 1C are illustrated in the top of FIG. 1A, e.g. optical waveguides 105, radio frequency (RF) phase modulator 106, direct current (DC) phase tuner 107, 1×1 MMI 108, 2×2 MMI 109, optical link 110, e.g. optical fiber 110; laser source 104, 302, and an optical coupler 306, e.g. a fiber coupler 306, which are also used in FIG. 3.

FIG. 1A shows a first comparative example of a light source chip 101 using an IQ-modulator configured with a 2×1 MMI as I and Q carrier combiner. Here, only one output port of this light source is used.

FIG. 1B shows a second comparative example of a light source chip 102 using an IQ-modulator configured with a 2×2 MMI as I- and Q-carrier combiner. Here, two are 2 output ports of the 2×2 MMI are available, but only one is used as light source chip output. The other of the two output ports is terminated with on chip optical absorber.

FIG. 1C illustrates an example of a light source chip configuration 300 using a 2×2 MMI to combine an I-carrier and a Q-carrier. Both output ports of the 2×2 MMI may serve as the inputs of chirp signals to LIDAR systems. The signals emitted from the two ports of the 2×2 MMI may have minimum interference due to a side band location difference. Each of the two output ports of the 2×2 MMI may power half of a LIDAR system. Alternatively, or in addition, the output ports of the 2×2 MMI may power two separate LIDAR systems.

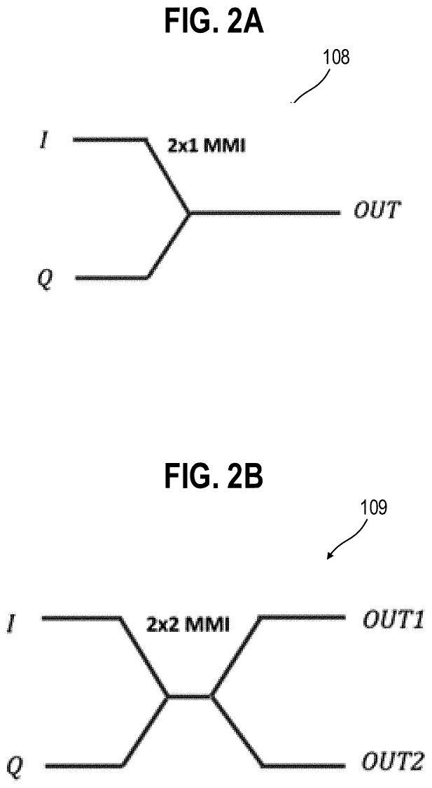

FIG. 2A illustrates the electric field transfer matrix for a 2×1 MMI of the first comparative example and FIG. 2B shows the electric field transfer matrix of the 2×2 MMI of the example to demonstrate the 3 dB power loss. FIG. 2A shows the port notation for a 2×1 MMI combiner 108 used in a Mach-Zehnder modulator (MZMI+Q) of FIG. 1A (input ports 1, Q and output port OUT), and FIG. 2B shows the port notation for a 2×2 MMI combiner 109 used in MZM_{I+Q} of FIG. 1B and FIG. 1C (input port I, Q and output ports OUT1, OUT2).

For a 2×1 MMI combiner in FIG. 2A, the output port electric field can be expressed as eq. 1, where E and θ represent the electric field amplitude and phase.

$${E}_{OUT} {e}^{j {θ}_{OUT}} = [ \frac{1}{\sqrt{2}} \frac{1}{\sqrt{2}} ] ( \begin{matrix}{E}_{I} {e}^{j {θ}_{I}} \\ {E}_{Q} {e}^{j {θ}_{Q}}\end{matrix} ) \qquad ( 1 )$$

The optical power in any waveguide system can be generally expressed as square of the electric field amplitude. Assume the input and output waveguide geometries are the same and only fundamental mode is been propagated through the waveguide, then optical power at each port can be calculated from the electric field amplitude through a conversion factor α. Power at input port can be expressed with eq. 2 and eq. 3.

$$\begin{matrix}{P}_{I} = α {E}_{I}^{2} & ( 2 ) \\ {P}_{Q} = α {E}_{Q}^{2} & ( 3 )\end{matrix}$$

To calculate the power at the output port, the square output electric field amplitude can be calculated by the product of eq. 1 and its conjugate. The calculation process is illustrated in eq. 4.1 to eq. 4.5, where the output power is dependent on the phase difference between I output port and Q output port.

$$\begin{matrix}{P}_{OUT} = α {E}_{OUT}^{2} & ( 4.1 ) \\ {P}_{OUT} = α {E}_{OUT} {e}^{j {θ}_{OUT}} \times {( {E}_{OUT} {e}^{j {θ}_{OUT}} )}^{*} & ( 4.2 ) \\ {P}_{OUT} = α \{ \frac{1}{2} {E}_{I}^{2} + \frac{1}{2} {E}_{Q}^{2} + {E}_{I} {E}_{Q} cos ( {θ}_{I} - {θ}_{Q} ) \} & ( 4.3 ) \\ {P}_{OUT} = \frac{1}{2} ( α {E}_{I}^{2} + α {E}_{Q}^{2} ) & ( 4.4 ) \\ {P}_{OUT} = \frac{1}{2} ( {P}_{I} + {P}_{Q} ) & ( 4.5 )\end{matrix}$$

For the IQ-modulator in FIG. 1A, the DC phase tuner in MZM_{I+Q} need to be tuned to create a 90° or −90° phase difference between the In-phase carrier and the quadrature carrier. Therefore, θ₁−θ_{Q}=±π/2.

Eq. 4.5 shows that the output power of the 2×1 MMI is only half of the input power from MZM_{I} and MZM_{Q}. Hence, the MMI combiner of the first comparative example illustrated in FIG. 1A has a 3 dB power loss.

For the 2×2 MMI combiner in FIG. 1B and FIG. 1C, the output port electric field can be expressed as eq. 5.

$$( \begin{matrix}{E}_{OUT 1} {e}^{j {θ}_{OUT 1}} \\ {E}_{OUT 2} {e}^{j {θ}_{{OUT}^{2}}}\end{matrix} ) = [ \begin{matrix}\frac{1}{\sqrt{2}} & \frac{1}{\sqrt{2}} {e}^{j \frac{π}{2}} \\ \frac{1}{\sqrt{2}} {e}^{j \frac{π}{2}} & \frac{1}{\sqrt{2}}\end{matrix} ] ( \begin{matrix}{E}_{I} {e}^{j {θ}_{I}} \\ {E}_{Q} {e}^{j {θ}_{Q}}\end{matrix} ) \qquad ( 5 )$$

From the transfer matrix in eq. 5, the cross path (Q input port to OUT1 output port, or I input port to OUT2 output port) has 90° phase increase relative to straight path (I input port to OUT1 output port, or Q input port to OUT2 output port), which create the 90° phase required for I-carrier and Q-carrier. Therefore, the DC phase tuner in MZMI+Q is set at 0, and θ_{I}−θ_{Q}=0 or π. The power at output1 is calculated in eq. 6.1 to eq. 6.5 and the power at output 2 is calculated in eq. 7.1 to eq. 7.5, respectively. The total power is shown in eq. 8.

$$\begin{matrix}{P}_{OUT 1} = α {E}_{OUT 1}^{2} & ( 6.1 ) \\ {P}_{OUT 1} = α {E}_{OUT 1} {e}^{j {θ}_{OUT 1}} \times {( {E}_{OUT 1} {e}^{j {θ}_{OUT 1}} )}^{*} & ( 6.2 ) \\ {P}_{OUT 1} = α \{ \frac{1}{2} {E}_{I}^{2} + \frac{1}{2} {E}_{Q}^{2} + {E}_{I} {E}_{Q} cos ( {θ}_{I} - {θ}_{Q} - \frac{π}{2} ) \} & ( 6.3 ) \\ {P}_{OUT 1} = \frac{1}{2} ( α {E}_{I}^{2} + α {E}_{Q}^{2} ) & ( 6.4 ) \\ {P}_{OUT 1} = \frac{1}{2} ( {P}_{I} + {P}_{Q} ) & ( 6.5 ) \\ {P}_{OUT 2} = α {E}_{OUT 2}^{2} & ( 7.1 ) \\ {P}_{OUT 2} = α {E}_{OUT 2} {e}^{j {θ}_{OUT 2}} \times {( {E}_{OUT 2} {e}^{j {θ}_{OUT 2}} )}^{*} & ( 7.2 ) \\ {P}_{OUT 2} = α \{ \frac{1}{2} {E}_{I}^{2} + \frac{1}{2} {E}_{Q}^{2} + {E}_{I} {E}_{Q} cos ( {θ}_{I} + \frac{π}{2} - {θ}_{Q} ) \} & ( 7.3 ) \\ {P}_{OUT 2} = \frac{1}{2} ( α {E}_{I}^{2} + α {E}_{Q}^{2} ) & ( 7.4 ) \\ {P}_{OUT 2} = \frac{1}{2} ( {P}_{I} + {P}_{Q} ) & ( 7.5 ) \\ {P}_{OUT 1} + {P}_{OUT 2} = {P}_{I} + {P}_{Q} & ( 8 )\end{matrix}$$

From eq. 8, it is clear the total output power from OUT1 output port and OUT2 output port combined will equal the total input power from I input port and Q input port combined. Each output port OUT1, OUT2 only contains half of the combined input power. Therefore, by using only 1 output port of the 2×2 MMI to power LIDAR system like in the comparative example 2 illustrated in FIG. 1B, 3 dB of optical power will be lost. Using both output ports of 2×2 MMI like in the example illustrated in FIG. 1C will enable 100% optical power utilized, e.g. by a LIDAR system.

FIG. 3 shows the signal and phase notation of an example of the IQ-modulator. The IQ-modulator may include at least a first Mach-Zehnder modulator MZM_{I} and a second Mach-Zehnder modulator MZMQ nested on a common substrate to generate carrier-suppressed single-sideband modulated (CS-SSB) signals. Sinusoidal RF signals may be applied to MZM_{I} and MZM_{Q} with a π/2 phase shift with respect to one another by using RF 90° hybrid coupler. To get a carrier-suppressed single-sideband modulation, the optical phase differences between the MZM_{I} and MZM_{Q}, φ_{I} and φ_{Q}, respectively, are each set at π, and the optical phase difference, φ_{I+Q}, for the 2 arms in MZM_{I+Q} may be set at 0 or π, corresponding to the upper side band or lower sideband signal for OUT2 output port, respectively. By sweeping the radio frequency (RF) frequency and the corresponding phase linearly, two optical signals with linear frequency chirped modulation are generated at the OUT1 output port and the OUT2 output port. The CS-SSB chirped signals for each output port may be send to half of a LIDAR system, as an example. As an example, the optical channels coupled to OUT1 output port may emit an optical signal, e.g. a first light, having a first frequency chirp, e.g. an up-chirp frequency (frequency increases, also denoted as chirp up frequency), and, e.g. simultaneously, the optical channels coupled to OUT2 output port may emit an optical signal, e.g. a second light, having a second frequency chirp, e.g. a down-chirp frequency (frequency decreases, also denoted as chirp down frequency), or vice versa. Alternatively, or in addition, the first frequency chirp and the second frequency chirp may be chirped the same direction, e.g. both up-chirp or down-chirp, but with different frequency change rate per time unit.

Phase setting, (φ_{I}, φ_{Q}, φ_{I+Q})=(π, π, 0), may be used to derive the electric field formula for OUT1 output port and OUT2 output port. The optical carrier frequency may be ƒ₀, the modulation index may be m, the chirp signal frequency may be f_{c}, the electric field amplitude at the input ports of the IQ-modulator may be E_{IN}. The electrical field of a phase modulated light in each arm I, Q of the MMI may be represented generally by e^{j2πƒ0t} e^{jƒ} e^{jm sin(2πƒmt)}.

The frequency modulated wave can be generally expressed using a Bessel function of the first kind of argument m. The electric field of phase modulated light at the I input port and the Q input port of FIG. 3 can be expressed in eq. 9.1 to eq. 9.2 and eq. 10.1 to eq. 10.2.

$$\begin{matrix}{E}_{I} ( t ) {e}^{j {θ}_{I} ( t )} = \frac{{E}_{IN}}{2 \sqrt{2}} {e}^{j 2 π {f}_{0} t} \{ {e}^{j \{ m sin ( 2 π {f}_{m} t ) + {φ}_{I} \}} + {e}^{j \{ m sin ( 2 π {f}_{m} t + π ) \}} \} & ( 9.1 ) \\ {E}_{I} ( t ) {e}^{j {θ}_{I} ( t )} = \frac{{E}_{IN}}{\sqrt{2}} {\sum }_{n = - ∞}^{+ ∞} {J}_{2 n + 1} ( m ) {e}^{j [ 2 π \{ {f}_{0} + ( 2 n + 1 ) {f}_{m} \} t + π ]} & ( 9.2 ) \\ {E}_{Q} ( t ) {e}^{j {θ}_{q} ( t )} = \frac{{E}_{IN}}{2 \sqrt{2}} {e}^{j 2 π {f}_{0} t} \{ {e}^{j \{ m sin ( 2 π {f}_{m} t + \frac{π}{2} ) + {φ}_{q} \}} + {e}^{j \{ m sin ( 2 π {f}_{m} t + \frac{3 π}{2} ) )} \} & ( 10.1 ) \\ {E}_{Q} ( t ) {e}^{j {θ}_{q} ( t )} = \frac{{E}_{IN}}{\sqrt{2}} {\sum }_{n = - ∞}^{+ ∞} {j}^{2 n + 1} {J}_{2 n + 1} ( m ) {e}^{j [ 2 π \{ {f}_{0} + ( 2 n + 1 ) {f}_{m} \} t + π ]} & ( 10.2 )\end{matrix}$$

When combining the electric field expression eq. 9.2 and eq. 10.2 of the I input port and the Q input port through the transfer matrix in eq. 5, the electric field equation for output port OUT1 and OUT2 is provided as in Eq11.1 to 11.2 and eq. 12. To eq 12.2.

$$\begin{matrix}{E}_{OUT 1} ( t ) {e}^{j {θ}_{OUT 1} ( t )} = \frac{{E}_{I} ( t )}{\sqrt{2}} {e}^{j {θ}_{I} ( t )} {e}^{{j }_{φ I + Q}} + \frac{{E}_{Q} ( t )}{\sqrt{2}} {e}^{j {θ}_{Q} ( t )} {e}^{j \frac{π}{2}} & ( 11.1 ) \\ {E}_{OUT 1} ( t ) {e}^{j {θ}_{OUT 1} ( t )} = {E}_{IN} {\sum }_{n = - ∞}^{+ ∞} {J}_{4 n - 1} ( m ) {e}^{j [ 2 π \{ {f}_{0} + ( 4 n - 1 ) {f}_{m} \} t + π ]} & ( 11.2 ) \\ {E}_{OUT 2} ( t ) {e}^{j {θ}_{OUT 2} ( t )} = \frac{{E}_{I} ( t )}{\sqrt{2}} {e}^{j {θ}_{I} ( t )} {e}^{j {φ}_{I + Q}} {e}^{j \frac{π}{2}} + \frac{{E}_{Q} ( t )}{\sqrt{2}} {e}^{j {θ}_{Q} ( t )} & ( 12.1 ) \\ {E}_{OUT 2} ( t ) {e}^{j {θ}_{OUT 2} ( t )} = {E}_{IN} {\sum }_{n = - ∞}^{+ ∞} {J}_{4 n + 1} ( m ) {e}^{j [ 2 π \{ {f}_{0} + ( 4 n + 1 ) {f}_{m} \} t + π ]} & ( 12.2 )\end{matrix}$$

As these equations 11.2, 12.2 indicate, the primary signal component for OUT1 output port is E_{IN}×J₋₁(m) e^{j[2π{ƒ0-ƒm}t+π]}, which is the lower side band relative to the carrier frequency. The primary signal component for OUT2 output port is E_{IN}×J₁(m) e^{j[2π{ƒ0+ƒm}t+π]}, which is the upper side band relative to the carrier frequency.

Similar analysis can be performed with (φ_{I}, φ_{Q}, φ_{I+Q})=(π, π, π), and the result will be a swapped signal expressions for eq. 11.2 and eq. 12.2.

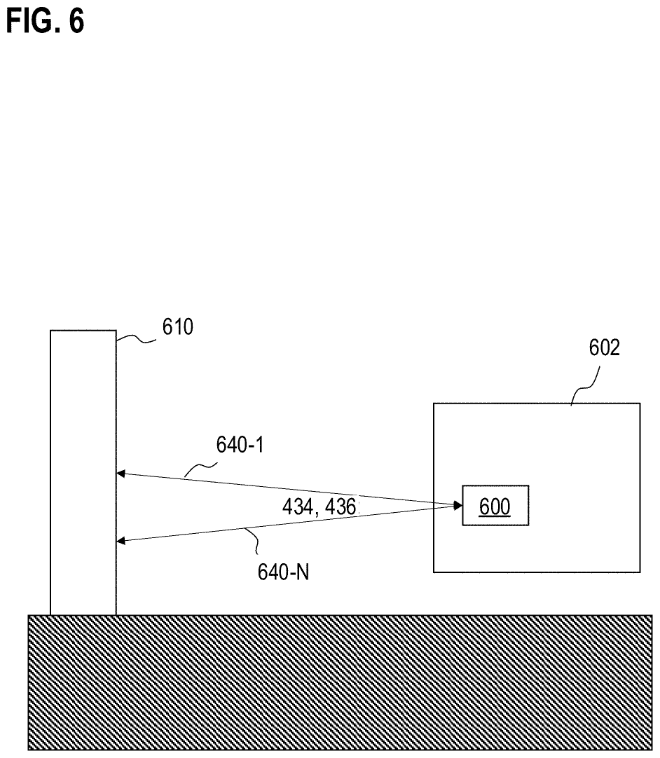

Further, the 2×2 MMI combiner, and in addition the light source 304, e.g. of the LIDAR system, may be attached to or integrated in a semiconductor substrate. The semiconductor substrate may have integrated therein at least one light receiving input 301-1, 301-2 to branch light provided from the 2×2 MMI combiner to one optical channel of a plurality of optical channels of one or more LIDAR systems (see FIG. 6).

Alternatively, the light source 304, e.g. the laser source 304, and/or the light receiving input 301-1, 301-2 may be external to the semiconductor substrate and coupled directly or indirectly, e.g. via a an optical link, e.g. an optical fiber; to the semiconductor substrate.

As an example, the LIDAR 300 system that may include a light source 302 configured to provide a second optical input signal φ_{Q} to a second input port Q of a MMI that may be phase shifted (θ) to a first optical input signal φ_{I} provided to a first input port I of the MMI. The MMI may be configured to provide a second optical output signal f₀+fₘ to a second set of one or more optical channels coupled to a second output port OUT2 of the MMI, and to provide the first optical output signal f₀−fₘ to a first set of one or more optical channels coupled to a first output port OUT1 of the MMI. Each of the optical channels of the first set and the second set may be configured to emit light to an outside of the LIDAR 300 system. The MMI may be configured to generate a frequency difference between the first optical output signal f₀−fₘ and the second optical output signal fₒ+fₘ.

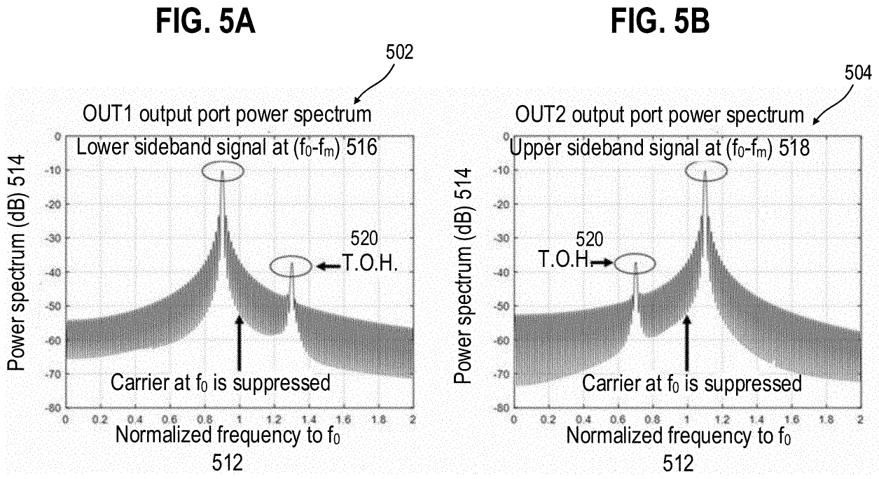

In other words, the LIDAR 300 system may include a MMI configured to provide a first optical output signal f₀−fₘ to a first set of one or more optical channels coupled to a first output port OUT1 of the MMI, and to provide a second optical output signal f₀+fₘ to a second set of one or more optical channels coupled to a second output port OUT2 of the MI. Each of the optical channels of the first set and the second set is configured to emit light to an outside of the LIDAR 300 system The MMI is configured that the first optical output signal f₀−fₘ and the second optical output signal f₀+fₘ are different side bands at a different frequency in a power spectra at the first optical output and the second optical output (see also FIG. 5A and FIG. 5B).

The light source 302 may include a light emitting semiconductor structure 304 configured to provide a coherent electromagnetic radiation, a first MZMI coupling the light emitting semiconductor structure 304 to the first input port I of the MMI; and a second MZMQ coupling the light emitting semiconductor structure 304 to the second input port Q of the MMI.

The light source 302 may include a phase shifter in at least one of the first MZM_{I} and the second MZM_{Q}. The phase shifter may include a heater configured to adjust a temperature of a waveguide of the MZM.

The first MZM_{I} may be optically isolated from the second MZM_{Q}.

The light emitting semiconductor structure 304, the first MZMI and the second MZM_{Q} may be integrated or arranged on a common substrate, e.g. a semiconductor substrate. Alternatively, the first MZM_{I} and the second MZM_{Q} may be integrated or arranged on a common substrate, and the light emitting semiconductor structure 304 may be attached to the substrate, e.g. the light emitting semiconductor structure 304 may be formed external to the substrate, e.g. on another (different) substrate. The substrate(s) may be a semiconductor substrate as described in more detail below.

The optical channel(s) of the first set and the optical channel(s) of the second set, and at least the MMI may be arranged or integrated on a common substrate. Alternatively, the optical channel(s) of the first set may be arranged or integrated on a (first) substrate and the optical channel(s) of the second set may be arranged or integrated on a another (second) substrate. As an example, this way two or more LIDAR (sub)systems may be provided with light by a single light source. As an example, the optical channel(s) of the first set may be optically coupled to a first lens, and the optical channel(s) of the second set may be optically coupled to a second lens. The substrate(s) may be a semiconductor substrate as described in more detail below.

Alternatively, the optical channel(s) of the first set and the optical channel(s) of the second set may be arranged or integrated on a common (first) substrate, and at least the MMI may be arranged or integrated on a another (second) substrate. The optical channel(s) of the first set and the optical channel(s) of the second set may be coupled via optical links to the first output and the second output of the MMI. The substrate(s) may be a semiconductor substrate as described in more detail below. For example, an optical link may be an optical connection, e.g. between two photonic chips, via a fiber or an on-chip silicon waveguide, e.g. as a single chip.

Each of the optical channel(s) of the first set and the optical channel(s) of the second set may include a balanced photodetector optically coupled to one of the first output and the second output of the MMI. The optical channel(s) of the first set and the optical channel(s) of the second set may be optically isolated from each other. At least one of the optical channel(s) of the first set and the optical channel(s) of the second set may include an optical frequency chirping structure. The first set may include a plurality of optical channels, and/or the second set may include a plurality of optical channels. Each of the optical channels of the first set and the second set may be optically coupled to an optical system that may include at least one of the group of a grating, a mirror, a quarter wave plate, a half wave plate, a lens. Each of the optical channels of the first set and the second set may be optically coupled to a common lens.

The semiconductor substrate may be made of a semiconductor material, e.g. silicon or germanium. The semiconductor substrate may be a common substrate, e.g. at least for the plurality of optical channels. The term “integrated therein” may be understood as formed from the material of the substrate and, thus, may be different to the case in which elements are formed, arranged or positioned on top of a substrate. The PIC includes a plurality of components located next to each other on the same (common) semiconductor substrate. The term “located next” may be interpreted as formed in or on the same (a common) semiconductor substrate.

The light source 304 may be configured to emit a coherent electromagnetic radiation of one or more wavelength. Through this specification any kind of usable of “electromagnetic radiation” is denoted as “light” for illustration purpose only and even though the electromagnetic radiation may not be in the frequency range of visible light, infrared light/radiation or ultraviolet light/radiation. The light source 304 may include a coherent electromagnetic radiation source.

The at least one light source 304 may be configured to provide coherent electromagnetic radiation (also denoted as coherent light), e.g. laser radiation in a visible light spectrum, an infrared spectrum, a terahertz spectrum and/or a microwave spectrum. As an example “light” may be visible light, infrared radiation, terahertz radiation or microwave radiation, and the optical components of the LIDAR system may be configured accordingly. The light source 304 may be configured to be operated as a continuous wave laser and/or a pulsed laser. The light source 304 may be configured to be operated as a continuous wave (CW) laser, e.g. for frequency modulated continuous wave (FMCW) LIDAR in which the frequency of the light input to the light receiving input is swept or chirped. However, the light source 304 may also be a CW laser, e.g. a CW laser diode, operated in a pulsed mode, e.g. quasi CW (QCW) laser.

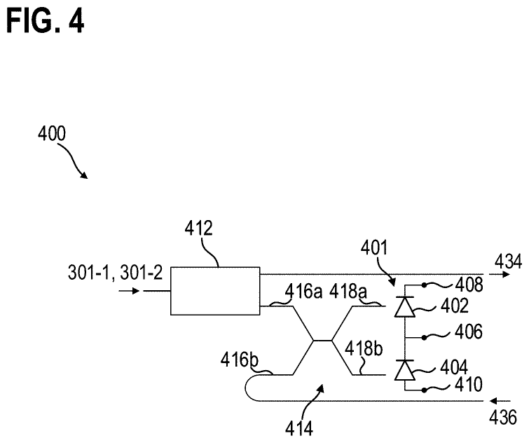

FIG. 4 exemplarily shows an emitter-detector structure 400 including a balanced photodetector 401 coupled to one of the output ports 301-1, 301-2 of the 2×2 MMI combiner of FIG. 3, e.g. implemented in a LIDAR system. It is understood that the representation of the LIDAR system may be simplified for the purpose of illustration, and the LIDAR system may include additional components with respect to those shown (e.g., a processing circuit, one or more additional optical components, etc.).

The 2×2 multimode interferometer (MMI) 414 may be configured to mix the local oscillator (LO) light and the target ranging signal light into two output ports 418a, 418b and feed them into the balanced photodetector 401. The balanced photodetector 401 may include two identical photodiodes 402, 404 with a common p- and n-electrodes coupled with one another at a common node 406 (e.g., between the common node 406 and a first supply node 408, and between the common node 406 and a second supply node 410, respectively).

In FIG. 4, the optical coupler 414 may be or may include a 2×2 multi-mode interferometer (MMI), with a first input waveguide 416a associated with (e.g., optically coupled with) the light source, a second input waveguide 416b associated with the field of view, a first output waveguide 418a associated with the first photodiode 402, and a second output waveguide 418b associated with the second photodiode 404. It is however understood that a 2×2 multi-mode interferometer is only an example of an optical component configured to enable the coherent detection, and other optical components may be provided to implement a same function.

The emitter-detector structure 400 may be configured for coherent LIDAR detection, e.g. for Frequency Modulated Continuous Wave (FMCW) LIDAR detection, illustratively for emission of continuous light having a varying frequency over time (e.g. a frequency varying from a starting frequency to a final frequency, and back). The coherent detection may include mixing (at the emitter-detector structure 400) light 416a from a light source (e.g. as illustrated in FIG. 3) with light 416b reflected back, e.g. from the field of view of the LIDAR system (e.g., from a target in the field of view—see FIG. 6). The shift in frequency between the emitted light 434 and the received light 436 provides determining one or more properties of the objects in the field of view (e.g., velocity, direction of motion, and the like), as known in the art. A Doppler shift caused by a moving target is not considered in the received light 416b. In other words, the target from which the light 436 is back reflected is considered as stationary in view of the velocity of the light 434 emitted by the light source.

The emitter-detector structure 400 may include a light source configured to emit light (e.g., frequency modulated light, for example the light source may include a local oscillator), and one or more optical components to provide part of the light to the balanced photodetector 401 and part of the light 434 towards the field of view. The one or more optical components may be configured such that the balanced photodetector 401 receives the light 301-1, 301-2 that the light source emits and the light 436 that is reflected back towards the emitter-detector structure 400 from the field of view, to provide coherent detection. Illustratively, the light that the light source emits may provide a reference light signal, and upon combination with the light from the field of view information may be derived on the objects present in the field of view.

As an example, the light source may be or may include a laser source. The laser source may be or may include a laser diode (e.g., a vertical cavity surface emitting laser diode or an edge-emitting laser diode) or a plurality of laser diodes (e.g., arranged in a one-dimensional or two-dimensional array). The light source may be configured to emit light in a predefined wavelength range, e.g. in accordance with a predefined detection scheme for the LIDAR system. As an example, the light source may be configured to emit light in the infrared or near-infrared wavelength range, e.g., in the range from about 700 nm to about 5000 nm, for example in the range from about 900 nm to about 2000 nm, or for example at 905 nm or 1550 nm.

The emitter-detector structure 400 may include an optical coupler 414 configured to receive a portion of the light that the light source emits (e.g., at a first input port 416a) and to receive light from the field of view (e.g., at a second input port 416b). The optical coupler 414 may be configured to optically couple the light from the field of view and the light that the light source emits with one another to provide output light. The optical coupler 414 may be configured to provide a first portion of the output light at the first photodiode 402 (at a first output port 418a optically coupled with the first photodiode 402) and a second portion of the output light at the second photodiode 404 (at a second output port 418b optically coupled with the second photodiode 404). The optical coupling and the differential detection that the balanced photodetector 401 provides determining differences between the light from the light source and light from the field of view.

As an example, FIG. 4 illustrates a CS-SSB light with linear frequency modulation utilized in a generic FMCW LIDAR receiver. The CS-SSB signal is first split into two parts 416a and 434. One part 416a serves as local oscillator (LO) signal directly injected into the balanced photodiodes 402, 404 through the upper port 418a of an optical coupler 414 configured as a 2×2 MMI. The other part 434 serves as the ranging signal and sent into an environment via an emitter optical system (not illustrated). The return signal 436 from the back reflection in the environment re-enters the LIDAR system via receiving optical system. The return signal 436 will then enter lower port 418b of the 2×2 MMI and eventually reach balanced photodiodes 402, 404. The differential signal between LO signal 416a and return signal 436 will be generated at balanced photodiodes at port V_{signal} 406, where the distance and relative velocity of the detected object regarding the LIDAR system can be decoded.

FIG. 5A shows the power spectrum 514 as a function of normalized frequency 512 of output port OUT1 502 and FIG. 5B shows the power spectrum 514 as a function of normalized frequency 512 of output port OUT2 504 (see also FIG. 3). The frequency f₀ is normalized to 1, and fₘ is set at f₀/10. Phase tuners are set at (φ_{I}, φ_{Q}, φ_{I+Q})=(π, π, 0), and modulation index m is set at 1. As the simulation result shows, the major peak signals are lower sideband signal at (f₀−fₘ) for OUT1 output port 516 and upper sideband signal at (f₀+fₘ) for OUT2 output port 518, and the carrier at frequency f₀ is suppressed. There are third order harmonics (T.O.H.) signal 520 present in both ports, but the T.O.H. is at least 20 dB lower than then major sideband signals and may not impact the system performance.

From FIG. 5A and FIG. 5B and eq. 11.2 and eq. 12.2, it becomes apparent that the output ports OUT1, OUT2 of the IQ-modulator provide two opposite side bands of CS-SSB signals 516, 518, which can both be utilized as signal source for a LIDAR system

FIG. 6 illustrates a schematic diagram of a vehicle 602 having a LIDAR system 600 integrated therein, as an example. The vehicle 602 may be an unmanned/autonomous vehicle, e.g. unmanned/autonomous aerial vehicle, unmanned/autonomous automobile, or autonomous robot. In addition, LIDAR system 600 may be used in a mobile device such as a smartphone or tablet. The vehicle 602 may be an autonomous vehicle. Here, the LIDAR system 600 may be used to control the direction of travel of the vehicle 602. The LIDAR system 600 may be configured for obstacle, object depth or velocity detection outside of the vehicle 602, as an example. Alternatively or in addition, the vehicle 602 may require a driver or teleoperator to control the direction of travel of the vehicle 602. The LIDAR system 600 may be a driving assistant. As an example, the LIDAR system 600 may be configured for obstacle detection, e.g. determining a distance and/or direction and relative velocity of an obstacle (target 610) outside of the vehicle 602. The LIDAR system 600 may be configured, along one or more optical channels 640-i (with i being one between 1 to N and N being the number of channels of a photonic integrated circuit of the LIDAR system 600 PIC), to emit light 434 (see also FIG. 4) from one or more outputs of the LIDAR system 600, e.g. outputs of the light paths, and to receive light 436 (see also FIG. 4) reflected from the target 610 in one or more light inputs of the LIDAR system 600. The structure and design of the outputs and inputs of the light paths of the LIDAR system 600 may vary depending on the working principle of the LIDAR system 600. Alternatively, the LIDAR system 600 may be or may be part of a spectrometer or microscope. However, the working principle may be the same as in a vehicle 602.

The plurality of optical channels 640-N may include the first set of optical channels and/or the second set of optical channels as described above, for example.

The structure and design of the outputs and inputs of the light paths of the LIDAR system 600 may also be integrated in a photonic integrated circuit (PIC) in a package or module, e.g. system in package (SIP) or system on module (SOM).

### EXAMPLES

The examples set forth herein are illustrative and not exhaustive.

Example 1 may be a light detection and ranging system that may include a light source configured to provide a second optical input signal to a second input port of a multimode interferometer that may be phase shifted to a first optical input signal provided to a first input port of the multimode interferometer. The multimode interferometer may be configured to provide a second optical output signal to a second set of one or more optical channels coupled to a second output port of the multimode interferometer, and to provide the first optical output signal to a first set of one or more optical channels coupled to a first output port of the multimode interferometer. Each of the optical channels of the first set and the second set may be configured to emit light to an outside of the light detection and ranging system. The MMI may be configured to generate a frequency difference between the first optical output signal and the second optical output signal.

In Example 2, the subject matter of Example 1 can optionally include that the light source may include a light emitting semiconductor structure configured to provide a coherent electromagnetic radiation, a first Mach-Zehnder modulator coupling the light emitting semiconductor structure to the first input port of the multimode interferometer; and a second Mach-Zehnder modulator coupling the light emitting semiconductor structure to the second input port of the multimode interferometer.

In Example 3, the subject matter of Example 2 can optionally include that the light source may include a phase shifter in at least one of the first Mach-Zehnder modulator and the second Mach-Zehnder modulator.

In Example 4, the subject matter of Example 3 can optionally include that the phase shifter may include a heater configured to adjust a temperature of a waveguide of the Mach-Zehnder modulator.

In Example 5, the subject matter of any one of Examples 2 to 4 can optionally include that the first Mach-Zehnder modulator may be optically isolated from the second Mach-Zehnder modulator.

In Example 6, the subject matter of any one of Examples 2 to 5 can optionally include that the light emitting semiconductor structure, the first Mach-Zehnder modulator and the second Mach-Zehnder modulator may be integrated or arranged on a common substrate.

In Example 7, the subject matter of any one of Examples 2 to 5 can optionally include that the first Mach-Zehnder modulator and the second Mach-Zehnder modulator may be integrated or arranged on a common substrate, and wherein the light emitting semiconductor structure may be attached to the substrate.

In Example 8, the subject matter of any one of Examples 1 to 7 can optionally include that the optical channel(s) of the first set and the optical channel(s) of the second set, and at least the multimode interferometer may be arranged or integrated on a common substrate.

In Example 9, the subject matter of any one of Examples 1 to 7 can optionally include that the optical channel(s) of the first set may be arranged or integrated on a first substrate and the optical channel(s) of the second set may be arranged or integrated on a second substrate.

In Example 10, the subject matter of any one of Examples 1 to 7 can optionally include that the optical channel(s) of the first set and the optical channel(s) of the second set may be arranged or integrated on a first substrate, and at least the multimode interferometer may be arranged or integrated on a second substrate.

In Example 11, the subject matter of Example 10 can optionally include that the optical channel(s) of the first set and the optical channel(s) of the second set may be coupled via optical fibers to the first output and the second output of the multimode interferometer.

In Example 12, the subject matter of any one of Examples 1 to 11 can optionally include that each of the optical channel(s) of the first set and the optical channel(s) of the second set may include a balanced photodetector optically coupled to one of the first output and the second output of the multimode interferometer.

In Example 13, the subject matter of any one of Examples 1 to 12 can optionally include that the optical channel(s) of the first set and the optical channel(s) of the second set may be optically isolated from each other.

In Example 14, the subject matter of any one of Examples 1 to 13 can optionally include that at least one of the optical channel(s) of the first set and the optical channel(s) of the second set may include an optical frequency chirping structure.

In Example 15, the subject matter of any one of Examples 1 to 14 can optionally include that the first set may include a plurality of optical channels, and/or the second set may include a plurality of optical channels.

In Example 16, the subject matter of any one of Examples 1 to 15 can optionally include that each of the optical channels of the first set and the second set may be optically coupled to an optical system that may include at least one of the group of a grating, a mirror, a quarter wave plate, a half wave plate, a lens.

In Example 17, the subject matter of any one of Examples 1 to 16 can optionally include that each of the optical channels of the first set and the second set may be optically coupled to a common lens.

In Example 18, the subject matter of any one of Examples 1 to 16 can optionally include that the one or more optical channel(s) of the first set may be optically coupled to a first lens and the one or more optical channel(s) of the second set may be optically coupled to a second lens.

Example 19 may be a light detection and ranging system that may include a multimode interferometer configured to provide a first optical output signal to a first set of one or more optical channels coupled to a first output port of the multimode interferometer, and to provide a second optical output signal to a second set of one or more optical channels coupled to a second output port of the MMI. Each of the optical channels of the first set and the second set is configured to emit light to an outside of the light detection and ranging system, wherein the multimode interferometer is configured that the first optical output signal and the second optical output signal are different side bands at a different frequency in a power spectra at the first optical output and the second optical output.

Example 20 is a light detection and ranging system including a light source configured to provide a second optical input signal to a second input port of a multimode interferometer that is phase shifted to a first optical input signal provided to a first input port of the multimode interferometer; wherein the multimode interferometer is configured to provide a second optical output signal to a second optical channel coupled to a second output port of the multimode interferometer, and to provide a first optical output signal to a first optical channel coupled to a first output port of the multimode interferometer, wherein each of the first optical channel and the second optical channel is configured to emit light to an outside of the light detection and ranging system, and wherein the multimode interferometer is configured to generate a frequency difference between the first optical output signal and the second optical output signal.

In Example 21, the subject matter of Example 20 can optionally include that the light source may include a light emitting semiconductor structure configured to provide a coherent electromagnetic radiation; a first Mach-Zehnder modulator coupling the light emitting semiconductor structure to the first input port of the multimode interferometer; and a second Mach-Zehnder modulator coupling the light emitting semiconductor structure to the second input port of the multimode interferometer.

In Example 22, the subject matter of Example 21 can optionally include that the light source may include a phase shifter in at least one of the first Mach-Zehnder modulator and the second Mach-Zehnder modulator.

In Example 23, the subject matter of Example 22 can optionally include that the phase shifter may include a heater configured to adjust a temperature of a waveguide of the Mach-Zehnder modulator.

In Example 24, the subject matter of Example 22 or 23 can optionally include that the first Mach-Zehnder modulator is optically isolated from the second Mach-Zehnder modulator.

In Example 25, the subject matter of any one of Examples 22 to 24 can optionally include that the light emitting semiconductor structure, the first Mach-Zehnder modulator and the second Mach-Zehnder modulator are integrated or arranged on a common substrate.

In Example 26, the subject matter of any one of Examples 22 to 25 can optionally include that the first Mach-Zehnder modulator and the second Mach-Zehnder modulator are integrated or arranged on a common substrate, and wherein the light emitting semiconductor structure is attached to the substrate.

In Example 27, the subject matter of any one of Examples 20 to 26 can optionally include that the first optical channel and the second optical channel, and at least the multimode interferometer are arranged or integrated on a common substrate.

In Example 28, the subject matter of any one of Examples 20 to 27 can optionally include that the first optical channel is arranged or integrated on a first substrate and the second optical channel is arranged or integrated on a second substrate.

In Example 29, the subject matter of any one of Examples 20 to 28 can optionally include that the first optical channel and the second optical channel are arranged or integrated on a first substrate, and at least the multimode interferometer is arranged or integrated on a second substrate.

In Example 30, the subject matter of Example 30 can optionally include that the first optical channel and the second optical channel are coupled via optical fibers to the first output and the second output of the multimode interferometer.

In Example 31, the subject matter of any one of Examples 20 to 30 can optionally include that each of the first optical channel and the second optical channel may include a balanced photodetector optically coupled to one of the first output and the second output of the multimode interferometer.

In Example 32, the subject matter of any one of Examples 20 to 31 can optionally include that the first optical channel and the second optical channel are optically isolated from each other.

In Example 33, the subject matter of any one of Examples 20 to 32 can optionally include that at least one of the first optical channel and the second optical channel may include an optical frequency chirping structure.

In Example 34, the subject matter of any one of Examples 20 to 33 can optionally include that the first optical channel is one optical channel of a first plurality of optical channels, wherein each optical channel of the plurality is optically coupled to the first output port of the multimode interferometer and configured to emit light to the outside of the light detection and ranging system, and/or that the second optical channel is one optical channel of a second plurality of optical channels, wherein each optical channel of the plurality is optically coupled to the second output port of the multimode interferometer and configured to emit light to the outside of the light detection and ranging system.

In Example 35, the subject matter of any one of Examples 20 to 34 can optionally include that the first optical channel and the second optical channel are optically coupled to a common lens.

In Example 36, the subject matter of any one of Examples 20 to 35 can optionally include that the first optical channel is optically coupled to a first lens and the second optical channel is optically coupled to a second lens.

Example 37 is a light detection and ranging system including a multimode interferometer configured to provide a first optical output signal to a first optical channel coupled to a first output port of the multimode interferometer, and to provide a second optical output signal to a second optical channel coupled to a second output port of the multimode interferometer, wherein each of the first optical channel and the second optical channel is configured to emit light to an outside of the light detection and ranging system, wherein the multimode interferometer is configured that the first optical output signal and the second optical output signal are different side bands at a different frequency in a power spectra at the first optical output and the second optical output.

In Example 38, the subject matter of Example 37 can optionally include a light source light source configured to provide a second optical input signal to a second input port of the multimode interferometer that is phase shifted to a first optical input signal provided to a first input port of the multimode interferometer, wherein the light source may include a light emitting semiconductor structure configured to provide a coherent electromagnetic radiation; a first Mach-Zehnder modulator coupling the light emitting semiconductor structure to the first input port of the multimode interferometer; and a second Mach-Zehnder modulator coupling the light emitting semiconductor structure to the second input port of the multimode interferometer.

In Example 39, the subject matter of any one of Examples 1 to 38 can include that the first optical channel includes a first optical frequency chirping structure and the second optical channel includes a second optical frequency chirping structure. The LIDAR system further includes one or more non-transitory computer readable media storing instruction thereon which, when executed by the system, cause the system to perform a method including: emitting a first light from the first optical channel, wherein the first light including aa first frequency chirp, and emitting a second light from the second optical channel, wherein the second light includes a second frequency chirp.

In Example 40, the subject matter of Example 39 can optionally include that the the first light and the second light are emitted simultaneously.

In Example 41, the subject matter of Example 39 or 40 can optionally include that the the first frequency chirp is an up-chiro and the second frequency chirp is a down-chirp.

Example 42 is a vehicle that may include a light detection and ranging system of any one of the Examples 1 to 41.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A light detection and ranging system comprising:
a light source configured to provide a second optical input signal to a second input port of a multimode interferometer that is phase shifted to a first optical input signal provided to a first input port of the multimode interferometer;
wherein the multimode interferometer is configured to provide a second optical output signal to a second optical channel coupled to a second output port of the multimode interferometer, and to provide a first optical output signal to a first optical channel coupled to a first output port of the multimode interferometer, wherein each of the first optical channel and the second optical channel is configured to emit light to an outside of the light detection and ranging system, and wherein the multimode interferometer is configured to generate a frequency difference between the first optical output signal and the second optical output signal.

2. The light detection and ranging system of claim 1,
wherein the light source comprises a light emitting semiconductor structure configured to provide a coherent electromagnetic radiation;
a first Mach-Zehnder modulator coupling the light emitting semiconductor structure to the first input port of the multimode interferometer; and
a second Mach-Zehnder modulator coupling the light emitting semiconductor structure to the second input port of the multimode interferometer.

3. The light detection and ranging system of claim 2,
wherein the light source comprises a phase shifter in at least one of the first Mach-Zehnder modulator and the second Mach-Zehnder modulator.

4. The light detection and ranging system of claim 3,
wherein the phase shifter comprises a heater configured to adjust a temperature of a waveguide of the Mach-Zehnder modulator,

5. The light detection and ranging system of claim 2,
wherein the first Mach-Zehnder modulator is optically isolated from the second Mach-Zehnder modulator.

6. The light detection and ranging system of claim 2,
wherein the light emitting semiconductor structure, the first Mach-Zehnder modulator and the second Mach-Zehnder modulator are integrated or arranged on a common substrate.

7. The light detection and ranging system of claim 2,
wherein the first Mach-Zehnder modulator and the second Mach-Zehnder modulator are integrated or arranged on a common substrate, and wherein the light emitting semiconductor structure is attached to the substrate.

8. The light detection and ranging system of claim 1,
wherein the first optical channel and the second optical channel, and at least the multimode interferometer are arranged or integrated on a common substrate.

9. The light detection and ranging system of claim 1,
wherein the first optical channel is arranged or integrated on a first substrate and the second optical channel is arranged or integrated on a second substrate.

10. The light detection and ranging system of claim 1,
wherein the first optical channel and the second optical channel are arranged or integrated on a first substrate, and at least the multimode interferometer is arranged or integrated on a second substrate.

11. The light detection and ranging system of claim 10, wherein the first optical channel and the second optical channel are coupled via optical fibers to the first output and the second output of the multimode interferometer.

12. The light detection and ranging system of claim 1,
wherein each of the first optical channel and the second optical channel comprises a balanced photodetector optically coupled to one of the first output and the second output of the multimode interferometer.

13. The light detection and ranging system of claim 1,
wherein the first optical channel and the second optical channel are optically isolated from each other.

14. The light detection and ranging system of claim 1,
wherein at least one of the first optical channel and the second optical channel comprises an optical frequency chirping structure.

15. The light detection and ranging system of claim 1,
wherein the first optical channel comprises a first optical frequency chirping structure and the second optical channel comprises a second optical frequency chirping structure; and
further comprising one or more non-transitory computer readable media storing instruction thereon which, when executed by the system, cause the system to perform a method comprising:
emitting a first light from the first optical channel, wherein the first light comprises a first frequency chirp, and
emitting a second light from the second optical channel, wherein the second light comprises a second frequency chirp.

16. The light detection and ranging system of claim 15,
wherein the first light and the second light are emitted simultaneously.

17. The light detection and ranging system of claim 15,
wherein the first frequency chirp is an up-chirp and the second frequency chirp is a down-chirp.

18. The light detection and ranging system of claim 1,
wherein the first optical channel is one optical channel of a first plurality of optical channels, wherein each optical channel of the plurality is optically coupled to the first output port of the multimode interferometer and configured to emit light to the outside of the light detection and ranging system, and/or
wherein the second optical channel is one optical channel of a second plurality of optical channels, wherein each optical channel of the plurality is optically coupled to the second output port of the multimode interferometer and configured to emit light to the outside of the light detection and ranging system.

19. The light detection and ranging system of claim 1,
wherein the first optical channel and the second optical channel are optically coupled to a common lens.

20. The light detection and ranging system of claim 1,
wherein the first optical channel is optically coupled to a first lens and the second optical channel is optically coupled to a second lens.

21. A vehicle comprising the light detection and ranging system of claim 1.

22. A light detection and ranging system comprising:
a multimode interferometer configured to provide a first optical output signal to a first optical channel coupled to a first output port of the multimode interferometer, and to provide a second optical output signal to a second optical channel coupled to a second output port of the multimode interferometer,
wherein each of the first optical channel and the second optical channel is configured to emit light to an outside of the light detection and ranging system, wherein the multimode interferometer is configured that the first optical output signal and the second optical output signal are different side bands at a different frequency in a power spectra at the first optical output and the second optical output.

23. The light detection and ranging system of claim 22,
further comprising a light source light source configured to provide a second optical input signal to a second input port of the multimode interferometer that is phase shifted to a first optical input signal provided to a first input port of the multimode interferometer, wherein the light source comprises a light emitting semiconductor structure configured to provide a coherent electromagnetic radiation;
a first Mach-Zehnder modulator coupling the light emitting semiconductor structure to the first input port of the multimode interferometer; and
a second Mach-Zehnder modulator coupling the light emitting semiconductor structure to the second input port of the multimode interferometer.
